(19) United States
(12) Patent Application Publication
(10) Pub. No.: US 2025/0296336 A1
(43) Pub. Date: Sep. 25, 2025

(54) LIQUID DISCHARGE HEAD, LIQUID DISCHARGE UNIT, AND LIQUID DISCHARGE APPARATUS

(71) Applicants: Kentaroh YAMANAKA, Kanagawa (JP); Takahiro YOSHIDA, Kanagawa (JP)

(72) Inventors: Kentaroh YAMANAKA, Kanagawa (JP); Takahiro YOSHIDA, Kanagawa (JP)

(21) Appl. No.: 19/081,037

(22) Filed: Mar. 17, 2025

(30) Foreign Application Priority Data
Mar. 22, 2024 (JP) 2024-046888

(51) Int. Cl. B41J 2/155; B41J 2/15; B41J 2/21

(52) U.S. Cl. CPC B41J 2/155; B41J 2/15; B41J 2/2146; B41J 2202/20

(57) ABSTRACT

A liquid discharge head includes multiple nozzle arrays each having nozzles arrayed in an array direction to discharge a liquid onto a medium being conveyed in a conveyance direction intersecting the array direction. The multiple nozzle arrays include a first nozzle array and a second nozzle array. The first nozzle array is disposed at the most downstream in the conveyance direction among the multiple nozzle arrays. The first nozzle array has the nozzles arranged at a first nozzle density in the array direction. The second nozzle array is disposed upstream from the first nozzle array in the conveyance direction. The second nozzle array has the nozzles arranged at a second nozzle density in the array direction lower than the first nozzle density.

### CROSS-REFERENCE TO RELATED APPLICATION

This patent application is based on and claims priority pursuant to 35 U.S.C. § 119(a) to Japanese Patent Application No. 2024-046888, filed on Mar. 22, 2024, in the Japan Patent Office, the entire disclosure of which is hereby incorporated by reference herein.

### BACKGROUND

### Technical Field

The present disclosure relates to a liquid discharge head, a liquid discharge unit, and a liquid discharge apparatus.

### Related Art

In a liquid discharge head, liquid is discharged from nozzles, and the liquid lands on a medium to form dots.

### SUMMARY

The present disclosure described herein provides an improved liquid discharge head including multiple nozzle arrays each having nozzles arrayed in an array direction to discharge a liquid onto a medium being conveyed in a conveyance direction intersecting the array direction. The multiple nozzle arrays include a first nozzle array and a second nozzle array. The first nozzle array is disposed at the most downstream in the conveyance direction among the multiple nozzle arrays. The first nozzle array has the nozzles arranged at a first nozzle density in the array direction. The second nozzle array is disposed upstream from the first nozzle array in the conveyance direction. The second nozzle array has the nozzles arranged at a second nozzle density in the array direction lower than the first nozzle density.

Further, the present disclosure described herein provides an improved liquid discharge head including three or more nozzle arrays each having nozzles arrayed in an array direction at a nozzle density to discharge a liquid onto a medium being conveyed in a conveyance direction intersecting the array direction. The three or more nozzle arrays include a downstream nozzle array disposed at the most downstream in the conveyance direction among the three or more nozzle arrays. The downstream nozzle array has the nozzle density equal to a sum of nozzle densities of a plurality of arrays of the three or more nozzle arrays disposed upstream from the downstream nozzle array in the conveyance direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A to 1C are schematic diagrams each illustrating liquid that lands on a medium;

FIG. 2 is a schematic plan view of nozzles arrayed according to a comparative example;

FIG. 3 is a schematic plan view of nozzles arrayed according to a first example;

FIG. 4 is a schematic plan view of nozzles arrayed according to a second example;

FIG. 5 is a schematic plan view of nozzles arrayed according to a third example;

FIG. 6 is a schematic plan view of nozzles arrayed according to a fourth example;

FIG. 7 is a schematic plan view of nozzles arrayed according to a fifth example;

FIG. 8 is a schematic plan view of nozzles arrayed according to a sixth example;

FIG. 9 is a schematic plan view of a liquid discharge apparatus;

FIG. 10 is a schematic side view of the liquid discharge apparatus of FIG. 9;

FIG. 11 is a schematic view of a liquid discharge unit;

FIG. 12 is another schematic view of a liquid discharge unit;

FIG. 13 is an exploded perspective view of a head module;

FIG. 14 is a further exploded perspective view of the head module of FIG. 13;

FIG. 15 is an exploded perspective view of the head module of FIG. 13 as viewed from a nozzle face side thereof;

FIG. 16 is a cross-sectional view of one head of the head module of FIG. 13 in a transverse direction of the head;

FIG. 17 is a schematic view of another liquid discharge apparatus;

FIG. 18 is a plan view of a head unit of the liquid discharge apparatus of FIG. 17;

FIG. 19 is a plan view of another head unit; and

FIG. 20 is a schematic view of still another liquid discharge apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge head, a liquid discharge unit, and a liquid discharge apparatus according to embodiments of the present disclosure are described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

In an embodiment of the present disclosure, a liquid discharge head includes multiple nozzle arrays having nozzles to discharge liquid onto a medium. The density of the nozzles arrayed in a nozzle array on an upstream side in the conveyance direction of the medium is lower than the density of the nozzles arrayed in a nozzle array on a most downstream side in the conveyance direction of the medium.

An airflow due to the conveyance of the medium and an airflow due to the discharged liquid are generated near the liquid discharge head. The medium is a discharge target of liquid, which may be referred to as a printing medium, a medium for printing, a recording medium, or an object onto which liquid is discharged. The airflow caused by the conveyance of the medium may be referred to as a conveyance airflow, and the airflow caused by the discharged liquid may be referred to as a discharge airflow. An airflow vortex may be generated due to interference between the conveyance airflow and the discharge airflow, and the landing position of the discharged liquid (e.g., ink) may be deviated due to the airflow vortex.

The airflow vortex generated on the upstream side in the conveyance direction of the medium may affect not only the landing position of the liquid discharged from the nozzles on the upstream side but also the landing position of the liquid discharged from the nozzles on the downstream side. In the liquid discharge head according to the present embodiment, the density of the nozzles on the upstream side in the conveyance direction of the medium is set to be lower than the density of the nozzles on the downstream side. Thus, the discharge airflow on the upstream side is weakened, and the interference between the conveyance airflow and the discharge airflow on the upstream side is prevented. As a result, the influence of the airflow vortex can be reduced, and the landing position of the liquid discharged from the nozzles on the upstream side and the downstream side can be prevented from deviating.

In addition, in the present embodiment, the deviation of the landing position of the liquid can be prevented without a complicated control mechanism in a system that changes the amount of liquid (ink) discharged on the downstream side according to the amount of liquid (ink) discharged on the upstream side, and thus a control mechanism can be prevented from being complicated. As a result, according to the present embodiment, the deviation of the landing position of the liquid can be prevented without a complicated control mechanism to form a desired image.

In the present specification, the upstream side in the conveyance direction of the medium may be referred to simply as an upstream side. The downstream side in the conveyance direction of the medium may be referred to simply as a downstream side. The density of the nozzles (i.e., a nozzle density) means the density of the nozzles arrayed in a nozzle array direction (may be referred to simply as an array direction) unless otherwise specified.

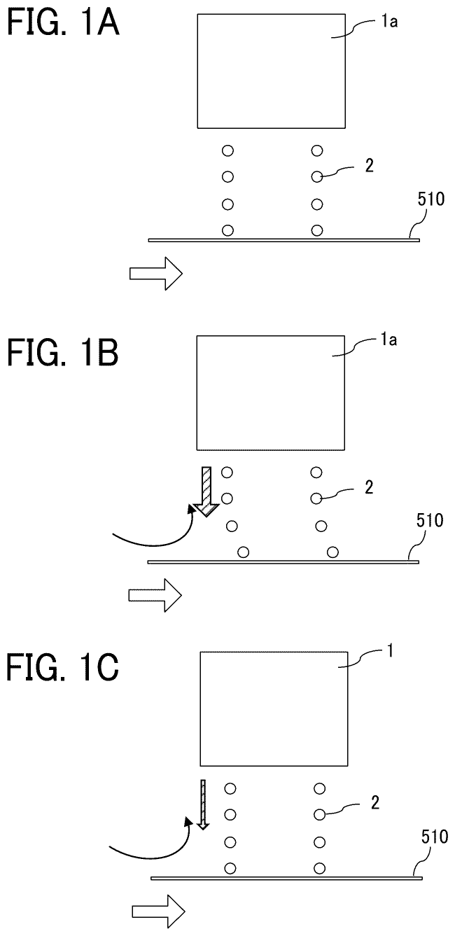

FIGS. 1A to 1C are schematic diagrams each illustrating a liquid discharge head discharging a liquid 2. In FIGS. 1A to 1C, blank arrows indicate the conveyance direction of a medium 510.

FIG. 1A illustrates ideal landing positions of the liquid 2 on the medium 510. If no airflow is generated by the conveyance of the medium 510, the liquid 2 discharged from a liquid discharge head 1a flies and lands vertically on the medium 510. However, in reality, the conveyance airflow is generated by the conveyance of the medium 510, and the discharge airflow is generated by the liquid 2 which is discharged from the liquid discharge head 1a and flies in a space. When the conveyance airflow and the discharge airflow interfere with each other, the airflow vortex is generated. Accordingly, the liquid 2 discharged from the liquid discharge head 1a lands at positions deviated from the ideal landing positions illustrated in FIG. 1A.

FIG. 1B is a schematic diagram illustrating the liquid 2 that is discharged from the liquid discharge head 1a and lands at the positions deviated from the ideal landing positions due to the airflow vortex. In FIGS. 1B and 1C, hatched arrows indicate the discharge airflow, and black arrows indicate the conveyance airflow. FIG. 1B schematically illustrates the interference between the discharge airflow and the conveyance airflow. In FIG. 1B, the black arrow indicating the conveyance airflow is curved, but the hatched arrow indicating the discharge airflow may be curved.

FIG. 1C is a schematic diagram illustrating the liquid 2 that is discharged from a liquid discharge head 1 and lands on the medium 510 in the present embodiment. As illustrated in FIG. 1C, in the present embodiment, the liquid discharge head 1 can prevent the deviation of the landing position of the liquid 2 on the medium 510 to form a desired image.

In the present embodiment, the liquid discharge head 1 has the nozzle density of the nozzles in the nozzle array on the upstream side lower than the nozzle density of the nozzles in the nozzle array on the downstream side to reduce the discharge airflow on the upstream side. Such an arrangement of the nozzle arrays reduces the influence of the airflow vortex generated by the interference between the discharge airflow and the conveyance airflow to reduce the deviation of the landing position of the liquid 2 on the medium 510. In the present embodiment, the liquid discharge head 1 can reduce the deviation of the landing position with the nozzle arrays having the nozzle densities described above. Accordingly, the control mechanism of the liquid discharge head or the apparatus does not become complicated.

### COMPARATIVE EXAMPLE

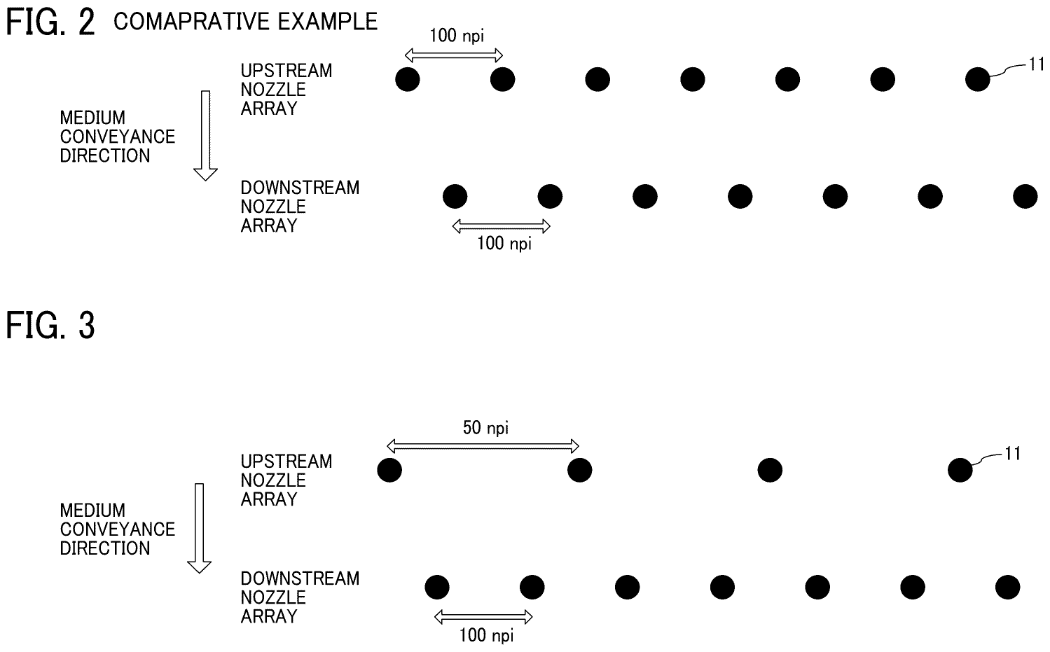

FIG. 2 is a schematic plan view of nozzles arrayed according to a comparative example. FIG. 2 illustrates the arrangement of nozzles 11. The blank arrow in FIG. 2 (the arrow pointing from the top to the bottom of the paper on which FIG. 2 is drawn) indicates the conveyance direction of the medium. The nozzle array on the upstream side in the conveyance direction of the medium may be referred to as an upstream nozzle array. The nozzle array on the most downstream side in the conveyance direction of the medium may be referred to as a most downstream nozzle array.

As illustrated in FIG. 2, the nozzle density of the upstream nozzle array (first row) in the conveyance direction of the medium is 100 nozzles per inch (npi), and the nozzle density of the most downstream nozzle array (second row) in the conveyance direction of the medium is 100 npi. In FIG. 2 and the other drawings, the downstream nozzle array means the most downstream nozzle array.

In a typical liquid discharge head, the nozzle density of the upstream nozzle array is the same as the nozzle density of the downstream nozzle array. In the comparative example, the nozzle densities are the same on the upstream side and the downstream side. When one color is used in the liquid discharge head, i.e., when the colors of liquid (ink) are the same in the upstream nozzle array and the downstream nozzle array, the density of dots in an image printed on the medium (i.e., a printing result) is 200 dots per inch (dpi). In addition, in the comparative example, the nozzle densities are the same on the upstream side and the downstream side. When two colors are used in the liquid discharge head, i.e., when the colors of liquid (ink) are different in the upstream nozzle array and the downstream nozzle array, the density of dots of each of the two colors in an image printed on the medium is 100 dpi.

The nozzle density (npi) can be calculated by selecting a straight line extending in the nozzle array direction and counting the nozzles per inch on the straight line. For example, when the nozzle densities are the same on the upstream side and the downstream side, a numerical value (%) expressed by {(nozzle density on upstream side−nozzle density on downstream side)/(nozzle density on upstream side)}×100 is less than ±1%.

In the comparative example, as illustrated in FIG. 1B, the landing position may deviate due to the airflow vortex generated by the interference between the discharge airflow caused by the upstream nozzle array and the conveyance airflow, and thus a desired image may not be obtained.

### First Example

FIG. 3 is a schematic plan view of nozzles arrayed according to a first example. FIG. 3 illustrates the arrangement of the nozzles 11. As illustrated in FIG. 3, the nozzle density of the upstream nozzle array is 50 npi, and the nozzle density of the downstream nozzle array is 100 npi. Accordingly, in the first example, the nozzle density of the upstream nozzle array is lower than the nozzle density of the downstream nozzle array. Such an arrangement of the nozzle arrays can weaken the discharge airflow from nozzles in the upstream nozzle array, and thus weaken the airflow vortex caused by the interference between the conveyance airflow and the discharge airflow on the upstream side to achieve the above-described effects of the present embodiment.

How much lower to make the nozzle density of the upstream nozzle array than the nozzle density of the downstream nozzle array can be appropriately selected. In the first example, the nozzle density of the upstream nozzle array is ½ of the nozzle density of the downstream nozzle array. The nozzle density of the upstream nozzle array is not limited thereto, and may be lower than ½ of the nozzle density of the downstream nozzle array.

The nozzle density of the upstream nozzle array is preferably, but is not limited to, within a range of 1/10 to ½ of the nozzle density of the most downstream nozzle array. Such a range of the nozzle density can weaken the discharge airflow caused by the nozzles in the upstream nozzle array and does not affect the printing result.

### Example 2

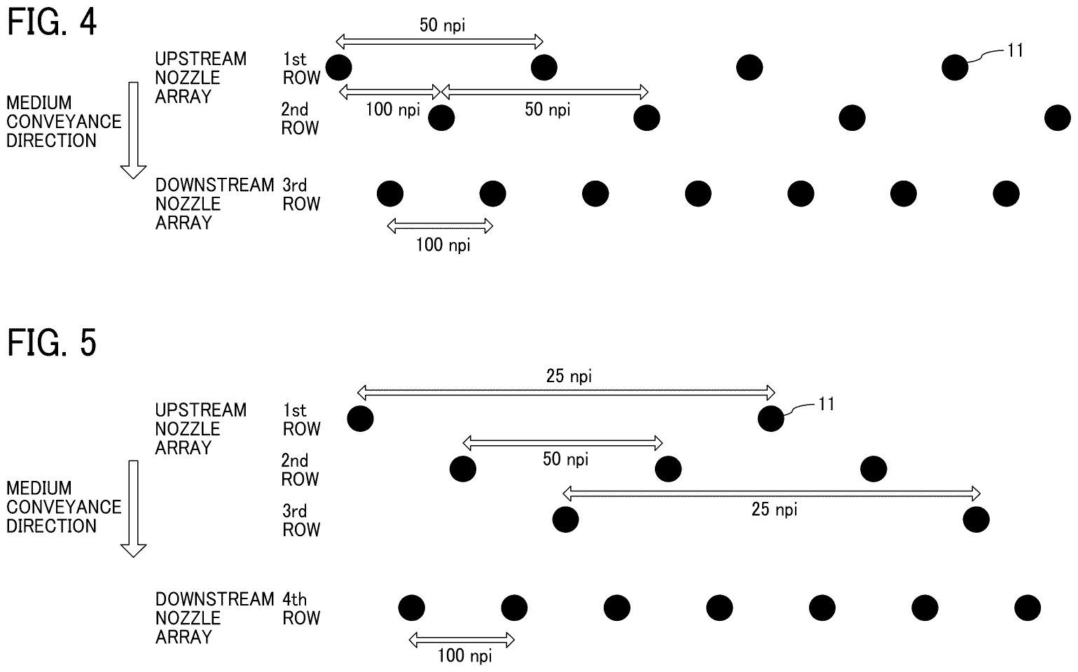

FIG. 4 is a schematic plan view of nozzles arrayed according to a second example. FIG. 4 illustrates the arrangement of the nozzles 11. In the second example, the nozzle arrays in the first and second rows from the upstream side in the conveyance direction of the medium are the upstream nozzle arrays, and the nozzle array in the third row is the most downstream nozzle array in the conveyance direction of the medium.

As illustrated in FIG. 4, the nozzle densities of the nozzle arrays in the first and second rows are both 50 npi. The nozzle density of the nozzle array in the third row, which is the most downstream nozzle array, is 100 npi. Accordingly, in the second example, the nozzle density of the upstream nozzle array in the conveyance direction of the medium is lower than the nozzle density of the most downstream nozzle array in the conveyance direction of the medium. Thus, in the second example, the discharge airflow caused by the nozzles in the upstream nozzle array is weakened, and thus the airflow vortex generated by the interference between the conveyance airflow and the discharge airflow on the upstream side can be weakened to achieve the effects of the present embodiment described above.

The multiple upstream nozzle arrays will be described below. When the nozzle density of the upstream nozzle array in the conveyance direction of the medium is lower than the nozzle density of the most downstream nozzle array in the conveyance direction of the medium, the nozzle densities of the upstream nozzle array and the downstream nozzle array are compared as follows. The first row which is one of the upstream nozzle arrays and the third row which is the most downstream nozzle array are compared, and the second row which is another of the upstream nozzle arrays and the third row which is the most downstream nozzle array are compared. As a result of the comparison, when the nozzle densities of both the first row and the second row are lower than the nozzle density of the third row, it can be said that the nozzle density of the upstream nozzle array is lower than the nozzle density of the most downstream nozzle array.

In the second example, the density of dots in an image printed on the medium by the upstream nozzle arrays in the conveyance direction of the medium is the same as the density of dots in an image printed on the medium by the most downstream nozzle array in the conveyance direction of the medium. In this case, the density of dots in an image printed on the medium by the upstream nozzle arrays in the conveyance direction of the medium is obtained by all dots formed by the upstream nozzle arrays in both the first row and the second row in the conveyance direction of the medium. In other words, the dots formed on the medium by the upstream nozzle array in the first and second rows are aligned in the nozzle array direction at the same position in the conveyance direction.

This point will be described in detail. The density of dots in an image printed on the medium can be calculated by counting dots in the image printed on the medium (i.e., the printing result) per inch. The unit of the density of dots calculated as described above is dpi. The density of dots may be referred to as a dot density. The dot density (dpi) in the printing result formed of the liquid discharged by the upstream nozzle arrays is a value obtained by adding the first row and the second row, i.e., 50 dpi+50 dpi=100 dpi. The dot density in the printing result by the downstream nozzle array (third row) is 100 dpi. Accordingly, the dot density (100 dpi) in the printing result formed by the upstream nozzle arrays (in the first row and second row) is the same as the dot density (100 dpi) in the printing result formed by the downstream nozzle array (in the third row). In other word, the downstream nozzle array disposed at the most downstream in the conveyance direction among the multiple nozzle arrays has a nozzle density equal to a sum of nozzle densities of a plurality of upstream nozzle arrays in the conveyance direction.

In the first example described above, the upstream nozzle array is a single row, and the nozzle density of the upstream nozzle array is reduced. Specifically, in the first example, the nozzle density of the upstream nozzle array is reduced from 100 npi to 50 npi. When the nozzle density is reduced as described above, the dot density in the printing result is also reduced, which may lead to deterioration of image quality.

Accordingly, in the second example, the nozzles are arrayed in the multiple (two) upstream nozzle arrays such that the dot density in the printing result formed by the upstream nozzle arrays is the same as the dot density in the printing result formed by the most downstream nozzle array in the conveyance direction of the medium. By so doing, in the second example, the discharge airflow caused by the upstream nozzle arrays can be weakened, and the dot density in the printing result is not reduced to enhance the image quality.

when the dot densities (dpi) are the same in the printing results by the upstream nozzle arrays and the downstream nozzle array, a numerical value (%) expressed by {(dot density on upstream side−dot density on downstream side)/(dot density on upstream side)}×100 is less than ±1%.

To make the dot densities the same on the upstream side and the downstream side, for example, the nozzles are preferably arrayed in a staggered manner in the multiple upstream nozzle arrays. In FIG. 4, the nozzles in the second row are shifted by 100 npi from the nozzles in the first row in the nozzle array direction, and the nozzles in the first and second rows are arrayed in the staggered manner. In addition, the most downstream nozzle array has the nozzles shifted in the nozzle array direction from the nozzles each of the multiple upstream nozzle arrays.

In the second example, the upstream nozzle arrays (in the first row and the second row) in the conveyance direction of the medium have a constant interval between the nozzles in the nozzle array direction. As illustrated in FIG. 4, in each of the upstream nozzle arrays in the first and second rows, the nozzles are arrayed at intervals of 50 npi.

As described above, the interval between the nozzles (i.e., a nozzle interval) in the nozzle array direction is constant in the upstream nozzle arrays. Accordingly, the nozzles in the upstream nozzle arrays can be arrayed in the staggered manner. As a result, dots formed on the medium by the upstream nozzle arrays are not overlapped with each other in the conveyance direction of the medium between the upstream nozzle arrays to enhance the image quality.

In the second example, the nozzle densities are the same in all the upstream nozzle arrays in the conveyance direction of the medium. The nozzle densities in the first and second rows illustrated in FIG. 4 are both 50 npi.

As described above, the nozzle densities are the same in the upstream nozzle arrays. Accordingly, the nozzles in the upstream nozzle arrays can be arrayed in the staggered manner. As a result, dots formed on the medium by the upstream nozzle arrays are not overlapped with each other in the conveyance direction of the medium between the upstream nozzle arrays to enhance the image quality.

In the second example, the number of the upstream nozzle arrays is, but is not limited to, two, and the number of the upstream nozzle arrays may be three or more.

In the second example, the nozzle densities of the upstream nozzle arrays are ½ of the nozzle density of the most downstream nozzle array. Specifically, the nozzle density (50 npi) in the first row is ½ of the nozzle density (100 npi) in the third row, and the nozzle density (50 npi) in the second row is ½ of the nozzle density (100 npi) in the third row.

### Third Example

FIG. 5 is a schematic plan view of nozzles arrayed according to a third example. FIG. 5 illustrates the arrangement of the nozzles 11. In the third example, the nozzle arrays in the first to third rows from the upstream side in the conveyance direction of the medium are the upstream nozzle arrays, and the nozzle array in the fourth row is the most downstream nozzle array in the conveyance direction of the medium.

As illustrated in FIG. 5, in the upstream nozzle arrays, the nozzle density in the first row is 25 npi, the nozzle density in the second row is 50 npi, and the nozzle density in the third row is 25 npi. The nozzle density of the most downstream nozzle array in the fourth row is 100 npi. Accordingly, in the third example, the nozzle density of the upstream nozzle array in the conveyance direction of the medium is lower than the nozzle density of the most downstream nozzle array in the conveyance direction of the medium. Thus, in the third example, the discharge airflow caused by the nozzles in the upstream nozzle array is weakened, and thus the airflow vortex generated by the interference between the conveyance airflow and the discharge airflow on the upstream side can be weakened to achieve the effects of the present embodiment described above.

In the third example, the nozzle density of the upstream nozzle array in the conveyance direction of the medium is lower than the nozzle density of the most downstream nozzle array in the conveyance direction of the medium, which will be described in detail. In the third example, the nozzle density (25 npi) in the first row is lower than the nozzle density (100 npi) in the fourth row, the nozzle density (50 npi) in the second row is lower than the nozzle density in the fourth row, and the nozzle density (25 npi) in the third row is lower than the nozzle density in the fourth row. Accordingly, in the third example, the nozzle density of the upstream nozzle array in the conveyance direction of the medium is lower than the nozzle density of the most downstream nozzle array in the conveyance direction of the medium.

In the second example, the nozzle densities are the same in the upstream nozzle arrays. Specifically, the nozzle densities in the first and second rows in FIG. 4 are both 50 npi. However, as in the third example, the nozzle densities may not be the same in all the upstream nozzle arrays. In the third example, as illustrated in FIG. 5, the nozzle densities in the first row, the second row, and the third row are 25 npi, 50 npi, and 25 npi, respectively. In other words, the nozzle densities in the first and third rows are the same, and different from the nozzle density in the second row.

When the nozzle densities are not the same in all the upstream nozzle arrays as in the third example, the relationship between the nozzle densities is preferably as follows. In the upstream nozzle arrays in the conveyance direction of the medium, preferably, the nozzle density of the most upstream nozzle array in the conveyance direction of the medium is the lowest compared to the nozzle densities of the other nozzle arrays.

In the third example, as illustrated in FIG. 5, the nozzle densities of the first, second, and third rows are 25 npi, 50 npi, and 25 npi, respectively, and the nozzle density of the most upstream nozzle array (in the first row) is the lowest.

However, in the upstream nozzle arrays, another nozzle array may have the same nozzle density as the nozzle density of the most upstream nozzle array (in the first row). In FIG. 5, the nozzle density in the third row is 25 npi, which is the same as the nozzle density in the first row, but in this case as well, the nozzle density of the most upstream nozzle array (in the first row) is said to be the lowest compared to the nozzle densities of the other nozzle arrays.

As in the third example, when the nozzle density of the most upstream nozzle array in the conveyance direction of the medium is the lowest compared to the nozzle densities of the other nozzle arrays, the interference between the discharge airflow and the conveyance airflow can be further prevented, and thus the deviation of the landing position can be reduced.

### Fourth Example

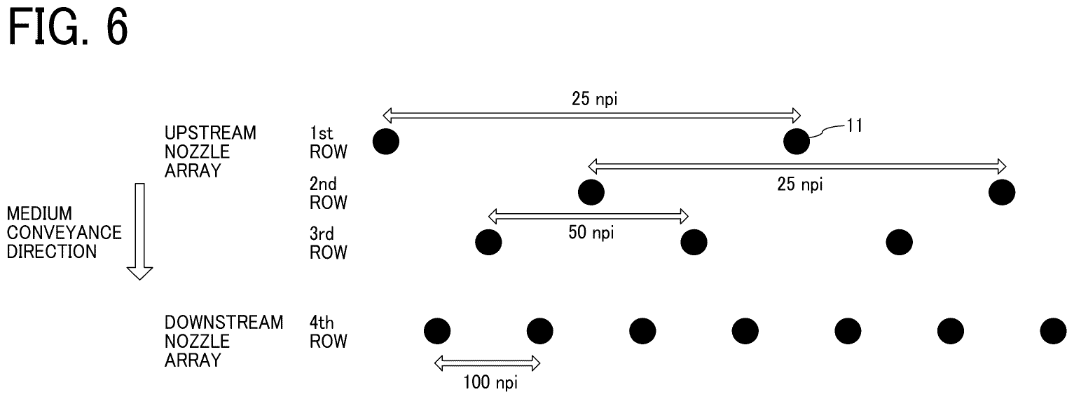

FIG. 6 is a schematic plan view of nozzles arrayed according to a fourth example. FIG. 6 illustrates the arrangement of the nozzles 11. In the fourth example, the nozzle arrays in the first to third rows from the upstream side in the conveyance direction of the medium are the upstream nozzle arrays, and the nozzle array in the fourth row is the most downstream nozzle array in the conveyance direction of the medium.

As illustrated in FIG. 6, in the upstream nozzle arrays, the nozzle density in the first row is 25 npi, the nozzle density in the second row is 25 npi, and the nozzle density in the third row is 50 npi. The nozzle density of the most downstream nozzle array in the fourth row is 100 npi.

In the fourth example, as in the examples described above, the nozzle density of the upstream nozzle array in the conveyance direction of the medium is lower than the nozzle density of the most downstream nozzle array in the conveyance direction of the medium. Thus, in the fourth example, the discharge airflow caused by the nozzles in the upstream nozzle array is weakened, and thus the airflow vortex generated by the interference between the conveyance airflow and the discharge airflow on the upstream side can be weakened to achieve the effects of the present embodiment described above.

In addition, in the fourth example, the upstream nozzle arrays satisfy the following relationship:

nozzle density in first row≤nozzle density in second row≤nozzle density in third row.

When this relationship is generalized, the following relationship is satisfied in the upstream nozzle arrays:

nozzle density in n-th row≤nozzle density in (n+1)-th row,

where n represents an integer of 1 or more.

According to this relationship, in the fourth example, one of the upstream nozzle arrays in the conveyance direction of the medium has a nozzle density equal to or higher than a nozzle density of an adjacent one of the upstream nozzle arrays adjacent to and upstream from the one of the upstream nozzle arrays. Such a relationship can further prevent the interference between the discharge airflow and the conveyance airflow to reduce the deviation of the landing position.

### Fifth Example

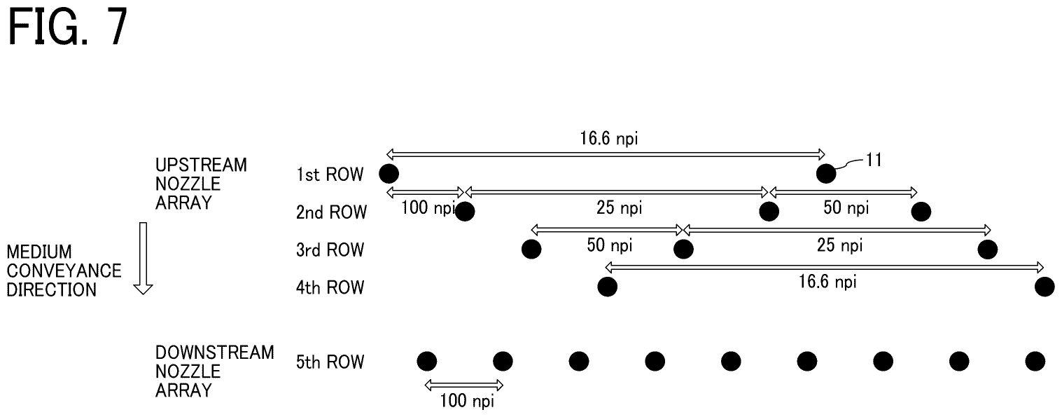

FIG. 7 is a schematic plan view of nozzles arrayed according to a fifth example. FIG. 7 illustrates the arrangement of the nozzles 11. In the fifth example, the nozzle arrays in the first to fourth rows from the upstream side in the conveyance direction of the medium are the upstream nozzle arrays, and the nozzle array in the fifth row is the most downstream nozzle array in the conveyance direction of the medium.

As illustrated in FIG. 7, in the upstream nozzle arrays, the nozzle density in each of the first row and the fourth row is 16.6 npi, which is constant, and the nozzle density in each of the second row and the third row is not constant. In other words, the nozzles are arrayed at even intervals in the first row and the fourth row, and the nozzles are arrayed at uneven intervals in the second row and the third row. In the upstream nozzle array in the second row, a portion having the nozzle density of 25 npi and a portion having the nozzle density of 50 npi are mixed. In the upstream nozzle array in the third row, a portion having the nozzle density of 50 npi and a portion having the nozzle density of 25 npi are mixed. The nozzle density of the most downstream nozzle array in the fifth row is 100 npi.

The nozzle densities of the upstream nozzle arrays in the second and third rows will be described below. In the upstream nozzle array in the second row, the portion having the nozzle density of 25 npi and the portion having the nozzle density of 50 npi are mixed. When portions having different nozzle densities are mixed in a nozzle array in one row, the nozzle density of the entire nozzle array in the one row can be obtained by a weighted average density weighted based on the ratio of the portions having the different nozzle densities. For example, when the ratio of the portion having the nozzle density of 25 npi to the portion having the nozzle density of 50 npi is 1:1, the average density is (25+50)/2=37.5 npi.

Similarly, in the upstream nozzle array in the third row, the portion having the nozzle density of 50 npi and the portion having the nozzle density of 25 npi are mixed. As described above, when portions having different nozzle densities are mixed in a nozzle array in one row, the nozzle density of the entire nozzle array in the one row can be obtained by a weighted average density weighted based on the ratio of the portions having the different nozzle densities. For example, when the ratio of the portion having the nozzle density of 50 npi to the portion having the nozzle density of 25 npi is 1:1, the average density is (50+25)/2=37.5 npi.

Although one portion having the nozzle density of 25 npi and one portion having the nozzle density of 50 npi are illustrated in each of the second and third rows in FIG. 7, in the upstream nozzle arrays in the second and third rows, the portion having the nozzle density of 25 npi and the portion having the nozzle density of 50 npi are alternately arranged.

In the fifth example, as in the examples described above, the nozzle density of the upstream nozzle array in the conveyance direction of the medium is lower than the nozzle density of the most downstream nozzle array in the conveyance direction of the medium. Thus, in the fifth example, the discharge airflow caused by the nozzles in the upstream nozzle array is weakened, and thus the airflow vortex generated by the interference between the conveyance airflow and the discharge airflow on the upstream side can be weakened to achieve the effects of the present embodiment described above.

Since the weighted average density weighted based on the ratio of the portions of the nozzle densities does not exceed the highest value of the nozzle densities, the nozzle density of the upstream nozzle array in each of the second and third rows does not exceed 50 npi. Accordingly, the nozzle density of the upstream nozzle array in each of the second and third rows is lower than the nozzle density of the most downstream nozzle array.

As described above, as in the second and third rows of the fifth example, the upstream nozzle array may have the nozzles arrayed at uneven intervals in the array direction. The phrase “the nozzles are arrayed at uneven intervals” may be expressed as the phrase “the nozzle density is not constant in the nozzle array.” Alternatively, the phrase “the nozzles are arrayed at uneven intervals” may be expressed as the phrase “the portions having the different nozzle densities are mixed in the nozzle array.”

In the fifth example, in the upstream nozzle arrays, preferably, the nozzle density of the most upstream nozzle array in the conveyance direction is the lowest compared to the nozzle densities of the other nozzle arrays. In other words, as illustrated in FIG. 7, in the upstream nozzle arrays, the nozzle density in the first row is preferably the lowest compared to the nozzle densities of the other nozzle arrays in the second to fourth rows. As illustrated in FIG. 7, the nozzle density in the first row is 16.6 npi, which is equal to or lower than the nozzle density of each of the second to fourth rows. Such an arrangement can prevent the interference with the conveyance airflow.

The fifth example will be described again.

In the fifth example, at least one of the upstream nozzle arrays in the conveyance direction of the medium has the nozzles arrayed at uneven intervals in the array direction, and the nozzle density of the most upstream nozzle array in the conveyance direction of the medium is the lowest compared to the nozzle densities of the other nozzle arrays in the upstream nozzle arrays.

### Sixth Example

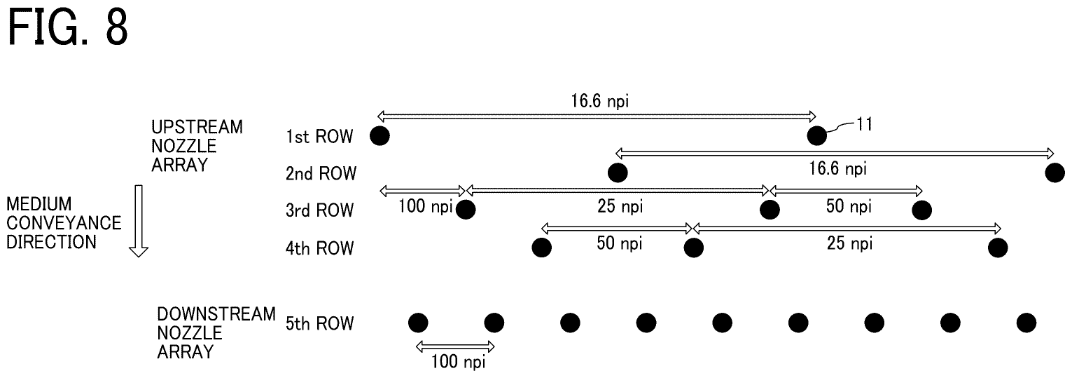

FIG. 8 is a schematic plan view of nozzles arrayed according to a sixth example. FIG. 8 illustrates the arrangement of the nozzles 11. In the sixth example, the nozzle arrays in the first to fourth rows from the upstream side in the conveyance direction of the medium are the upstream nozzle arrays, and the nozzle array in the fifth row is the most downstream nozzle array in the conveyance direction of the medium.

As illustrated in FIG. 8, in the upstream nozzle arrays, the nozzle density in each of the first row and the second row is 16.6 npi, which is constant. In the upstream nozzle array in the third row, a portion having the nozzle density of 25 npi and a portion having the nozzle density of 50 npi are mixed. In the upstream nozzle array in the fourth row, a portion having the nozzle density of 50 npi and a portion having the nozzle density of 25 npi are mixed. The nozzle density of the most downstream nozzle array in the fifth row is 100 npi.

Similarly to the fifth example described above, the nozzle density of the upstream nozzle array in each of the third and fourth rows can be obtained by a weighted average density weighted based on the ratio of the portions having the different nozzle densities. For example, when the ratio of the portion having the nozzle density of 25 npi to the portion having the nozzle density of 50 npi is 1:1, the average density is (25+50)/2=37.5 npi.

Although one portion having the nozzle density of 25 npi and one portion having the nozzle density of 50 npi are illustrated in each of the third and fourth rows in FIG. 8, in the upstream nozzle arrays in the third and fourth rows, the portion having the nozzle density of 25 npi and the portion having the nozzle density of 50 npi are alternately arranged.

In the sixth example, as in the examples described above, the nozzle density of the upstream nozzle array in the conveyance direction of the medium is lower than the nozzle density of the most downstream nozzle array in the conveyance direction of the medium. Thus, in the sixth example, the discharge airflow caused by the nozzles in the upstream nozzle array is weakened, and thus the airflow vortex generated by the interference between the conveyance airflow and the discharge airflow on the upstream side can be weakened to achieve the effects of the present embodiment described above.

Since the weighted average density weighted based on the ratio of the portions of the nozzle densities does not exceed the highest value of the nozzle densities, the nozzle density of the upstream nozzle array in each of the third and fourth rows does not exceed 50 npi. Accordingly, the nozzle density of the upstream nozzle array in each of the third and fourth rows is lower than the nozzle density of the most downstream nozzle array.

In the sixth example, the nozzle density in each of the first and second rows is 16.6 npi. The nozzle density of the upstream nozzle array in each of the third and fourth rows can be obtained by a weighted average density weighted based on the ratio of the portions of the nozzle densities. Since the weighted average density weighted based on the ratio of the portions of the nozzle densities does not fall below the lowest value of the nozzle densities, the nozzle density of the upstream nozzle array in each of the third and fourth rows does not fall below 25 npi. Accordingly, in the sixth example, the upstream nozzle arrays satisfy the following relationship:

nozzle density in first row≤nozzle density in second row≤nozzle density in third row≤nozzle density in fourth row.

When this relationship is generalized, the following relationship is satisfied in the upstream nozzle arrays:

nozzle density in n-th row≤nozzle density in (n+1)-th row,

where n represents an integer of 1 or more

According to this relationship, in the sixth example, one of the upstream nozzle arrays in the conveyance direction of the medium has a nozzle density equal to or higher than a nozzle density of an adjacent one of the upstream nozzle arrays adjacent to and upstream from the one of the upstream nozzle arrays. Such a relationship can further prevent the interference between the discharge airflow and the conveyance airflow to reduce the deviation of the landing position.

In the third and fourth rows of the sixth example, similarly to the second and third rows of the fifth example, the nozzle density is not constant (i.e., the intervals between the nozzles are uneven in the array direction). In the sixth example, at least one of the upstream nozzle arrays in the conveyance direction of the medium has the nozzles arrayed at uneven intervals in the array direction, and the nozzle density of the most upstream nozzle array in the conveyance direction of the medium is the lowest compared to the nozzle densities of the other nozzle arrays in the upstream nozzle arrays.

### Liquid Discharge Unit and Liquid Discharge Apparatus

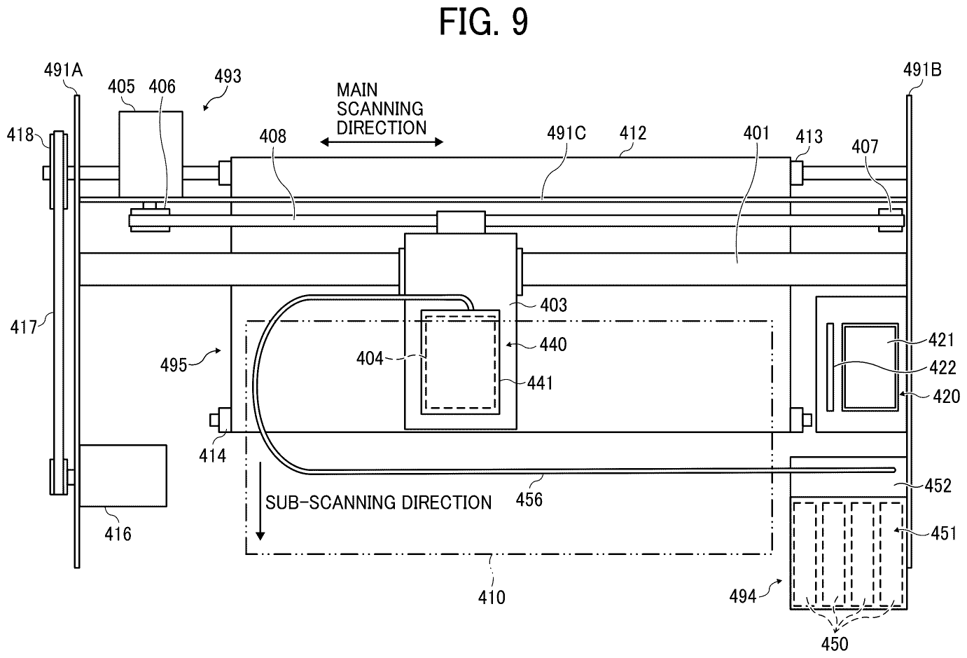

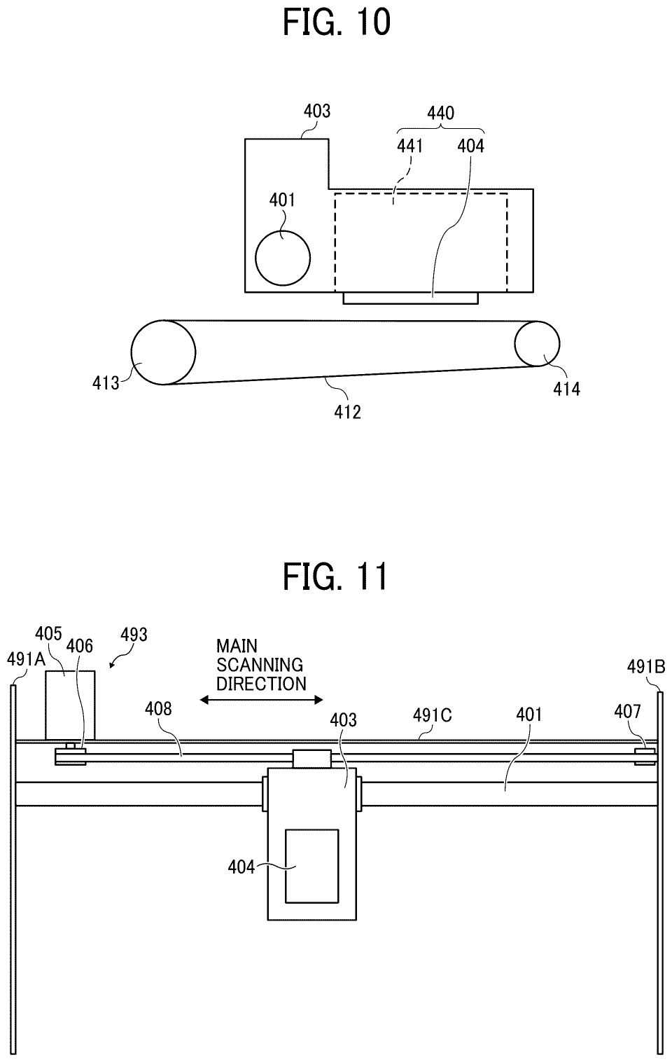

A liquid discharge apparatus according to an embodiment of the present disclosure is described below with reference to FIGS. 9 and 10. FIG. 9 is a plan view of a portion of a liquid discharge apparatus. FIG. 10 is a side view of the portion of the liquid discharge apparatus of FIG. 9.

The liquid discharge apparatus is a serial-type apparatus in which a main-scanning moving mechanism 493 reciprocates a carriage 403 in a main scanning direction. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 includes a liquid discharge unit 440 in which a liquid discharge head 404 and a head tank 441 are integrated into a single unit. The liquid discharge head 404 of the liquid discharge unit 440 discharges color liquids of, for example, yellow (Y), cyan (C), magenta (M), and black (K). The liquid discharge head 404 is mounted on the liquid discharge unit 440 of the carriage 403 such that a row of the multiple nozzles 11 is arrayed in the sub-scanning direction perpendicular to the main scanning direction. The liquid discharge head 404 discharges the color liquid downward.

A supply mechanism 494 disposed outside the liquid discharge head 404 supplies liquid stored in liquid cartridges 450 to the head tank 441 to supply the liquid to the liquid discharge head 404. The supply mechanism 494 includes a cartridge holder 451 which is a loading device to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410 (i.e., a medium). The conveyance mechanism 495 includes a conveyance belt 412 (i.e., a conveyor) and a sub-scanning motor 416 to drive the conveyance belt 412. The conveyance belt 412 attracts the sheet 410 and conveys the sheet 410 to a position facing the liquid discharge head 404. The conveyance belt 412 is an endless belt looped around a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 404 is disposed lateral to the conveyance belt 412. The maintenance mechanism 420 includes, for example, a cap 421 to cap the nozzle face (i.e., the surface on which the nozzles 11 are formed) of the liquid discharge head 404 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the liquid discharge apparatus having the above-described configuration, the sheet 410 is fed and attracted onto the conveyance belt 412 and conveyed in the sub-scanning direction as the conveyance belt 412 circumferentially moves. The liquid discharge head 404 is driven in response to an image signal while the carriage 403 moves in the main scanning direction to discharge liquid onto the sheet 410 not in motion. As a result, an image is formed on the sheet 410.

As described above, the liquid discharge apparatus includes the liquid discharge head according to an embodiment of the present disclosure, thus allowing the stable formation of high-quality images.

Another liquid discharge unit according to an embodiment of the present disclosure is described below with reference to FIG. 11. FIG. 11 is a plan view of a part of a liquid discharge unit. The liquid discharge unit includes the housing, the main-scanning moving mechanism 493, the carriage 403, and the liquid discharge head 404 among the components of the liquid discharge apparatus described above. The side plates 491A and 491B, and the back plate 491C construct the housing. The liquid discharge unit may further include at least one of the maintenance mechanism 420 or the supply mechanism 494, which may be attached to the side plate 491B.

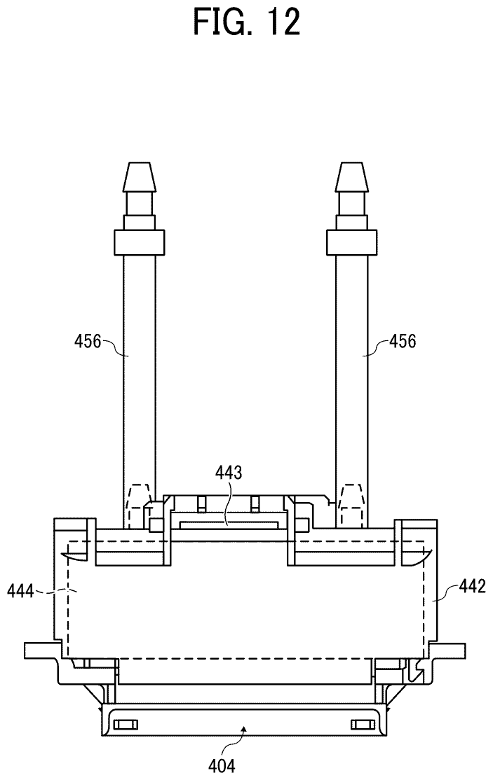

Still another liquid discharge unit according to an embodiment of the present disclosure is described below with reference to FIG. 12. FIG. 12 is a front view of the liquid discharge unit. The liquid discharge unit includes the liquid discharge head 404 to which a channel component 444 is attached, and tubes 456 connected to the channel component 444. The channel component 444 is disposed inside a cover 442. Alternatively, the liquid discharge unit 440 may include the head tank 441 instead of the channel component 444. A connector 443 for electrically connecting to the liquid discharge head 404 is disposed on an upper portion of the channel component 444.

In the above-described embodiments, the “liquid discharge apparatus” includes the liquid discharge head or the liquid discharge unit and drives the liquid discharge head to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head. In consideration of the interference of airflows, the line type is preferable.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

Examples of the liquid discharge unit include the liquid discharge unit 440 in which a liquid discharge head and a head tank are integrated, as illustrated in FIG. 10. Alternatively, the liquid discharge head and the head tank coupled (connected) to each other, for example, via a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit illustrated in FIG. 11, the liquid discharge head, the carriage, and the main-scanning moving mechanism may form the liquid discharge unit as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 12.

The main-scanning moving mechanism may be a guide only. The supply mechanism may be a tube(s) only or a loading device only.

The pressure generator used in the liquid discharge head is not limited to a particular type of pressure generator. The pressure generator is not limited to the piezoelectric actuator (or a laminated-type piezoelectric element) described in the above-described embodiments, and may be, for example, a thermal actuator that employs a thermoelectric transducer element, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

### Another Liquid Discharge Unit and Another Liquid Discharge Apparatus

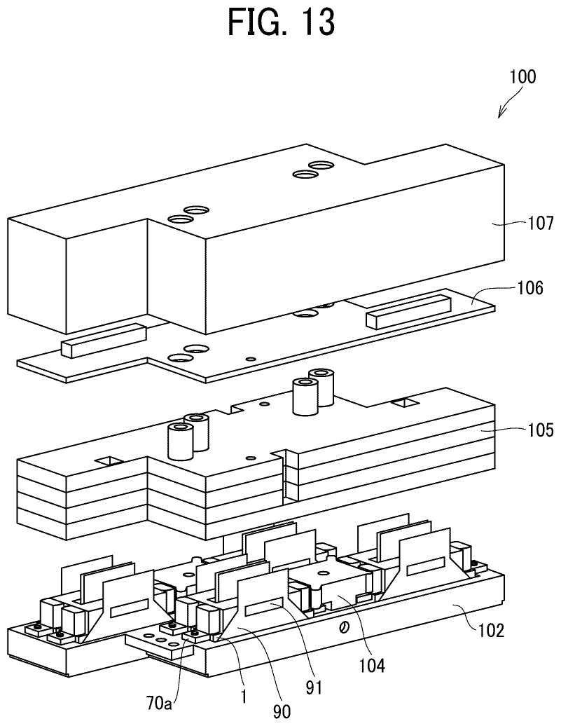

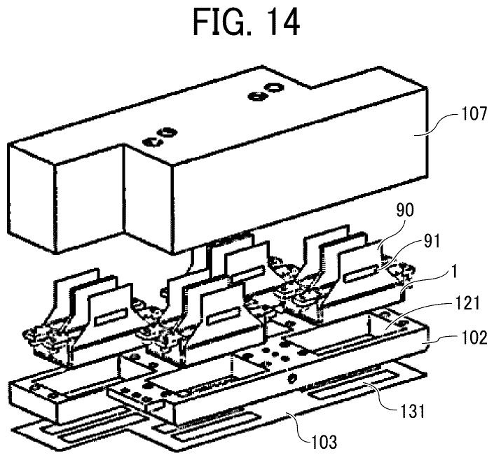

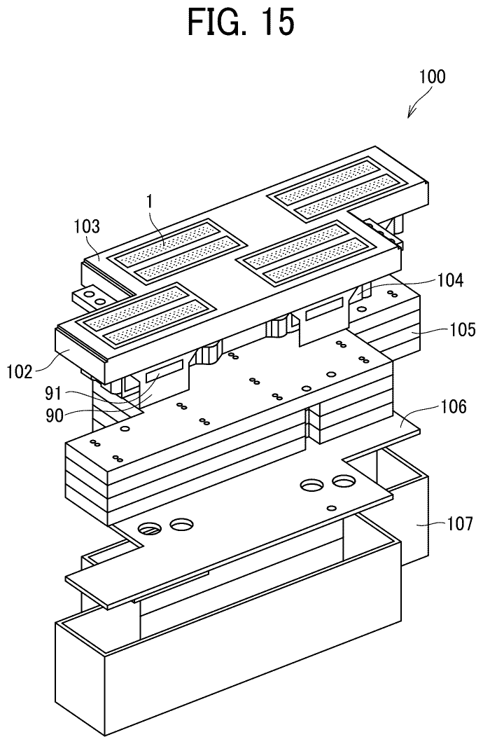

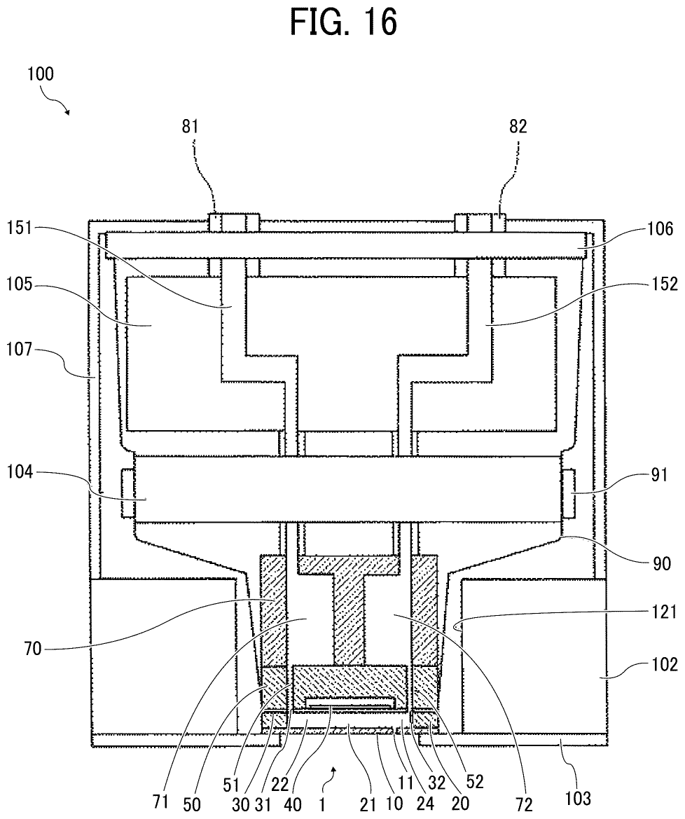

Another liquid discharge unit and another liquid discharge apparatus will be described below. The liquid discharge head or the liquid discharge unit of the present embodiment may be a head module. FIG. 13 is an exploded perspective view of a head module according to the present embodiment. FIG. 14 is a further exploded perspective view of the head module of FIG. 13. FIG. 15 is an exploded perspective view of the head module of FIG. 13 as viewed from a nozzle face side. FIG. 16 is a cross-sectional view of one head of the head module of FIG. 13 in a transverse direction of the head.

A head module 100 includes multiple heads 1 to discharge a liquid, a base 102, a cover 103, a heat radiator 104, a manifold 105, a printed circuit board (PCB) 106, and a module case 107.

The head 1 includes a nozzle plate 10, an individual channel plate 20, a diaphragm 30, an intermediate channel plate 50, and a common channel substrate 70. The nozzles 11 are formed in the nozzle plate 10. The individual channel plate 20 defines pressure chambers 21 communicating with the nozzles 11, respectively. The diaphragm 30 includes a piezoelectric element 40. The intermediate channel plate 50 is laminated on the diaphragm 30. The common channel substrate 70 is laminated on the intermediate channel plate 50.

In addition to the pressure chambers 21, the individual channel plate 20 defines individual supply channels 22 communicating with the pressure chambers 21 and individual collection channels 24 communicating with the pressure chambers 21, respectively.

The intermediate channel plate 50 defines intermediate supply channels 51 and intermediate collection channels 52. The intermediate supply channels 51 communicate with the individual supply channels 22 via openings 31 of the diaphragm 30, respectively. The intermediate collection channels 52 communicate with the individual collection channels 24 via openings 32 of the diaphragm 30, respectively.

The common channel substrate 70 defines a common supply channel 71 communicating with the intermediate supply channels 51 and a common collection channel 72 communicating with the intermediate collection channels 52. The common supply channel 71 communicates with a supply port 81 via a channel 151 of the manifold 105. The common collection channel 72 communicates with a collection port 82 via a channel 152 of the manifold 105.

The PCB 106 and the piezoelectric element 40 of the head 1 are connected to each other via a flexible wiring 90, and a driver integrated circuit (IC) 91 is mounted on the flexible wiring 90. Each of the multiple heads 1 is inserted into an opening 121 of the base 102, and the peripheral edge of the nozzle plate 10 of the head 1 is bonded to the cover 103 bonded and fixed to the base 102 with an adhesive to fix the head 1. The cover 103 has an opening 131 corresponding to the region of the nozzles 11 of the nozzle plate 10, and the cover 103 covers the peripheral edge of the nozzle plate 10 of the head 1. A flange 70a disposed outside the common channel substrate 70 in the longitudinal direction of the head 1 is bonded and fixed to the base 102.

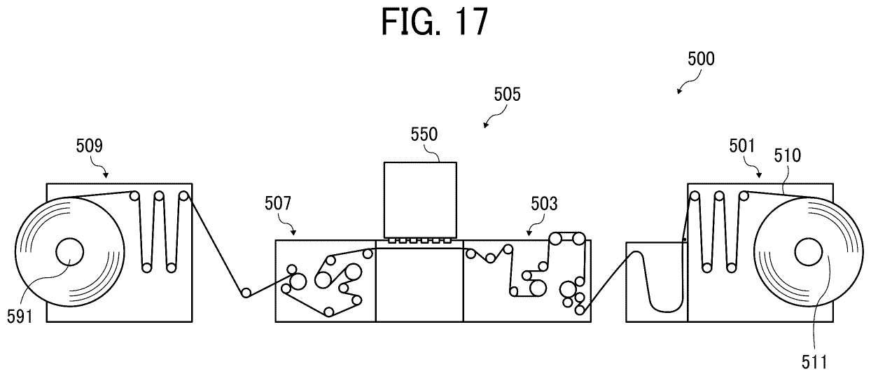

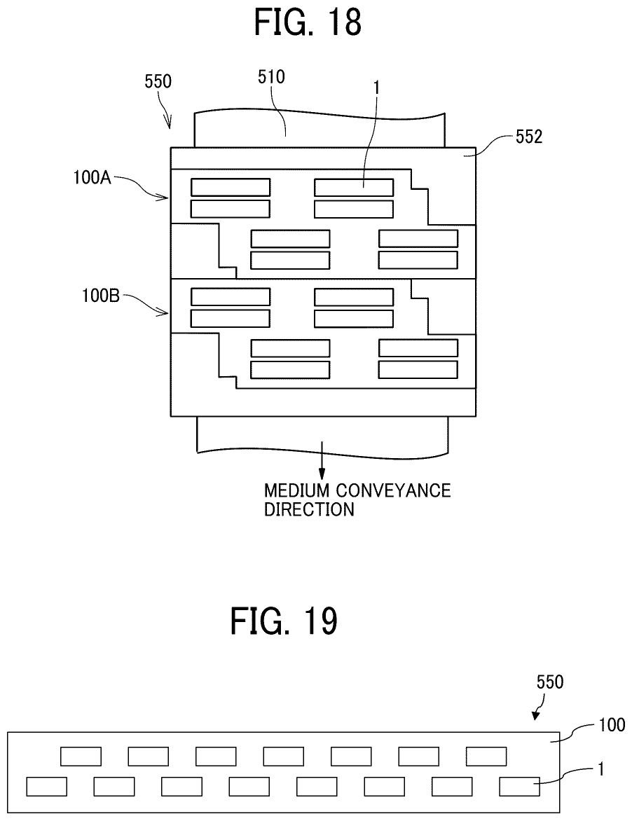

Another liquid discharge apparatus according to the present embodiment will be described below with reference to FIGS. 17 and 18. FIG. 17 is a schematic view of the liquid discharge apparatus. FIG. 18 is a plan view of a head unit of the liquid discharge apparatus illustrated in FIG. 17.

A printer 500 as a liquid discharge apparatus includes a feeder 501, a guide conveyor 503, a printing device 505, a dryer 507, and a carrier 509. The feeder 501 feeds a continuous medium 510 inward. The guide conveyor 503 guides and conveys the continuous medium 510 such as a continuous sheet of paper or a sheet medium fed inward from the feeder 501. The printing device 505 performs printing by discharging liquid onto the continuous medium 510 to form an image. The dryer 507 dries the continuous medium 510 with the image formed. The carrier 509 feeds the dried continuous medium 510 outward.

The continuous medium 510 (i.e., a medium) is fed from a winding roller 511 of the feeder 501, guided and conveyed with rollers of the feeder 501, the guide conveyor 503, the dryer 507, and the carrier 509, and wound around a take-up roller 591 of the carrier 509. In the printing device 505, the continuous medium 510 is conveyed so as to face a head unit 550. The head unit 550 discharges a liquid onto the continuous medium 510 to form an image.

As illustrated in FIG. 18, the head unit 550 includes two head modules 100A and 100B on a common base 552. FIG. 19 is a schematic diagram illustrating another head unit 550. As illustrated in FIG. 19, in the head module 100, the arrangement of the liquid discharge head 1 can be appropriately changed. For example, as illustrated in FIG. 19, the liquid discharge heads 1 may be arranged in a staggered manner.

### Electrode Manufacturing Apparatus

The liquid discharge apparatus according to an embodiment of the present disclosure may also include an apparatus for manufacturing an electrode and an electrochemical element that is also referred to as an electrode manufacturing apparatus. The electrode manufacturing apparatus is described below.

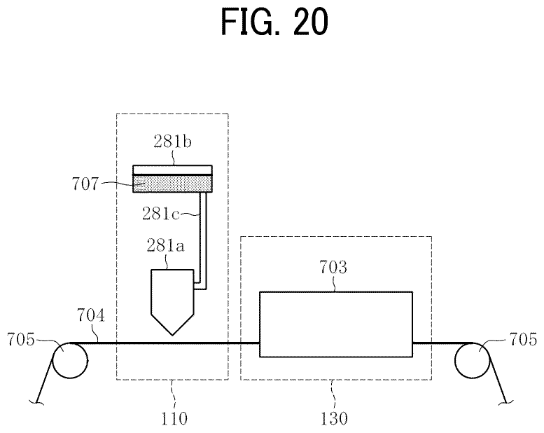

FIG. 20 is a schematic view of an electrode manufacturing apparatus. The electrode manufacturing apparatus is an apparatus for manufacturing an electrode including a layer containing an electrode material by discharging a liquid composition using a head module including a liquid discharge head.

### Device for Forming Layer Containing Electrode Material and Process of Forming Layer Containing Electrode Material

A discharge device in the electrode manufacturing apparatus illustrated in FIG. 20 is the head module according to the above-described embodiments of the present disclosure. The liquid discharge head of the head module discharges a liquid composition. By so doing, the liquid composition is applied onto an object (i.e., a medium), and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector.

The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus that forms an electrode composite layer containing an active material on an electrode substrate, i.e., a current collector, is described below.

As illustrated in FIG. 20, the electrode manufacturing apparatus includes a discharge process device 110 and a heating process device 130. The discharge process device 110 performs a discharge process of applying a liquid composition onto a print base material 704 having a discharge target to form a liquid composition layer. The heating process device 130 performs a heating process of heating the liquid composition layer to obtain an electrode composite layer.

The electrode manufacturing apparatus includes a conveyor 705 that conveys the print base material 704 (i.e., a medium). The conveyor 705 conveys the print base material 704 to the discharge process device 110 and the heating process device 130 in this order at a preset speed. A method of producing the print base material 704 having the discharge target such as an active material layer is not limited to any particular method, and a known method can be appropriately selected.

The discharge process device 110 includes a liquid discharge head 281a that performs an application process of applying the liquid composition onto the print base material 704, a storage container 281b that stores a liquid composition 707, and a supply tube 281c that supplies the liquid composition 707 stored in the storage container 281b to the liquid discharge head 281a. The discharge process device 110 discharges the liquid composition 707 from the liquid discharge head 281a so that the liquid composition 707 is applied onto the print base material 704 to form a liquid composition layer in a thin film shape.

The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130. Accordingly, the solvent is removed from the liquid composition layer. Thus, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

Aspects of the present disclosure are, for example, as follows.

### Aspect 1

A liquid discharge head includes multiple nozzle arrays in which nozzles that discharge a liquid onto a medium are arrayed. A nozzle density of a nozzle array on an upstream side (i.e., an upstream nozzle array) in a conveyance direction of the medium is lower than a nozzle density of a nozzle array on a most downstream side (i.e., a most downstream nozzle array) in the conveyance direction of the medium.

In other words, a liquid discharge head includes multiple nozzle arrays each having nozzles arrayed in an array direction to discharge a liquid onto a medium being conveyed in a conveyance direction intersecting the array direction. The multiple nozzle arrays include a first nozzle array and a second nozzle array. The first nozzle array is disposed at the most downstream in the conveyance direction among the multiple nozzle arrays. The first nozzle array has the nozzles arranged at a first nozzle density in the array direction. The second nozzle array is disposed upstream from the first nozzle array in the conveyance direction. The second nozzle array has the nozzles arranged at a second nozzle density in the array direction lower than the first nozzle density.

### Aspect 2

In the liquid discharge head according to Aspect 1, the number of upstream nozzle arrays in the conveyance direction of the medium is two or more, and a dot density in a printing result formed by the upstream nozzle arrays in the conveyance direction of the medium is the same as a dot density in a printing result formed by the most downstream nozzle array in the conveyance direction of the medium. However, the dot density in the printing result formed by the upstream nozzle arrays in the conveyance direction of the medium is obtained by adding up the dots formed by the upstream nozzle arrays in the conveyance direction of the medium.

In other words, the multiple nozzle arrays include multiple second nozzle arrays including the second nozzle array. The first nozzle array discharges the liquid from the nozzles onto the medium to form a first image on the medium. The first image has first dots arranged at a first dot density. The multiple second nozzle arrays discharge the liquid from the nozzles to form a second image on the medium. The second image has second dots arranged at a second dot density equal to the first dot density. The second dot density is obtained by summing a number of the second dots in the multiple second nozzle arrays.

### Aspect 3

In the liquid discharge head according to Aspect 1 or 2, the upstream nozzle array in the conveyance direction of the medium has a constant nozzle interval in the nozzle array direction.

In other words, the second nozzle array has the nozzles arrayed at even intervals in the array direction.

### Aspect 4

In the liquid discharge head according to any one of Aspects 1 to 3, the nozzle density is the same in all the upstream nozzle arrays in the conveyance direction of the medium.

In other words, the multiple nozzle arrays include multiple second nozzle arrays including the second nozzle array. Each of the multiple second nozzle arrays has the nozzles arranged at the same nozzle density.

### Aspect 5

In the liquid discharge head according to any one of Aspect 1 to 4, in the upstream nozzle arrays in the conveyance direction of the medium, a nozzle density of a nozzle array on the most upstream side in the conveyance direction of the medium is the lowest compared to nozzle densities of other nozzle arrays.

In other words, the multiple nozzle arrays include multiple second nozzle arrays including the second nozzle array. The second nozzle array includes an upstream second nozzle array disposed at the most upstream of the multiple second nozzle arrays in the conveyance direction. The upstream second nozzle array has the lowest second nozzle density in the second nozzle density of each of the multiple second nozzle arrays.

### Aspect 6

In the liquid discharge head according to Aspect 5, in the upstream nozzle arrays in the conveyance direction of the medium, a nozzle density of a nozzle array on the downstream side is equal to or higher than a nozzle density of a nozzle array on the immediately upstream side.

In other words, one of the multiple second nozzle arrays has the second nozzle density equal to or higher than the second nozzle density of an adjacent one of the multiple second nozzle arrays adjacent to and upstream from the one of the multiple second nozzle arrays in the conveyance direction.

### Aspect 7

In the liquid discharge head according to Aspect 1 or 2, the upstream nozzle arrays in the conveyance direction of the medium include at least one nozzle array in which the nozzle intervals in the nozzle array direction are not constant. A nozzle density of a nozzle array on the most upstream side in the conveyance direction of the medium is the lowest compared to the nozzle density of the other nozzle arrays in the upstream nozzle arrays.

In other words, the multiple nozzle arrays include multiple second nozzle arrays including the second nozzle array. At least one of the multiple second nozzle arrays has the nozzles arrayed at uneven intervals in the array direction. The second nozzle array includes an upstream second nozzle array disposed at the most upstream of the multiple second nozzle arrays in the conveyance direction and the upstream second nozzle array has the lowest second nozzle density in the second nozzle density of each of the multiple second nozzle arrays.

### Aspect 8

In the liquid discharge head according to Aspect 7, in the upstream nozzle arrays in the conveyance direction of the medium, a nozzle density of a nozzle array on the downstream side is equal to or higher than a nozzle density of a nozzle array on the immediately upstream side.

In other words, one of the multiple second nozzle arrays has the second nozzle density equal to or higher than the second nozzle density of an adjacent one of the multiple second nozzle arrays adjacent to and upstream from the one of the multiple second nozzle arrays in the conveyance direction.

### Aspect 9

A liquid discharge unit includes the liquid discharge head according to any one of Aspects 1 to 8.

In other words, a liquid discharge unit includes multiple liquid discharge head including the liquid discharge head according to any one of Aspects 1 to 8.

### Aspect 10

The liquid discharge unit according to Aspect 9, further includes at least one of a head tank to store a liquid to be supplied to the liquid discharge head, a carriage to mount the liquid discharge head, a supply mechanism to supply the liquid to the liquid discharge head, a maintenance mechanism to maintain and recover the liquid discharge head, or a main-scanning moving mechanism to move the liquid discharge head in a main scanning direction. The at least one thereof is integrated with the liquid discharge head as a single unit.

In other words, a liquid discharge unit includes the liquid discharge head according to any one of Aspects 1 to 9 and at least one of a head tank to store a liquid to be supplied to the liquid discharge head, a carriage to mount the liquid discharge head, a supply mechanism to supply the liquid to the liquid discharge head, a maintenance mechanism to maintain and recover the liquid discharge head, or a main-scanning moving mechanism to move the liquid discharge head in a main scanning direction. The at least one thereof is integrated with the liquid discharge head as a single unit.

### Aspect 11

A liquid discharge apparatus includes the liquid discharge head according to any one of Aspects 1 to 8 or the liquid discharge unit according to Aspect 9 or 10.

In other words, a liquid discharge apparatus includes the liquid discharge head according to any one of Aspects 1 to 8 and a conveyor to convey the medium to the liquid discharge head.

### Aspect 12

A liquid discharge apparatus includes the liquid discharge unit according to Aspect 9 or 10 and a conveyor to convey the medium to the liquid discharge unit.

### Aspect 13

A liquid discharge apparatus includes the liquid discharge head according to Aspect 2 and a conveyor to convey the medium to the liquid discharge head.

### Aspect 14

In the liquid discharge apparatus according to Aspect 13, the multiple second nozzle arrays discharge the liquid from the nozzles to form the second image having the second dots aligned in the array direction at the same position in the conveyance direction on the medium.

### Aspect 15

In the liquid discharge head according to Aspect 2, one of the multiple second nozzle arrays has the nozzles shifted in the array direction from the nozzles of an adjacent one of the multiple second nozzle arrays adjacent to and upstream from the one of the multiple second nozzle arrays in the conveyance direction.

### Aspect 16

In the liquid discharge head according to Aspect 15, the first nozzle array has the nozzles shifted in the array direction from the nozzles of each of the multiple second nozzle arrays.

### Aspect 17

In the liquid discharge head according to Aspect 2, a number of the multiple second nozzle arrays is three or more. The multiple second nozzle arrays include an upstream second nozzle array disposed at the most upstream of the multiple second nozzle arrays in the conveyance direction and a downstream second nozzle array disposed at the most downstream of the multiple second nozzle arrays in the conveyance direction. The upstream second nozzle array has the same second nozzle density as the downstream second nozzle array. Other nozzle arrays of the multiple second nozzle arrays other than the upstream second nozzle array and the downstream second nozzle array have the second nozzle density higher than the same second nozzle density of the upstream second nozzle array and the downstream second nozzle array.

### Aspect 18

A liquid discharge head includes three or more nozzle arrays each having nozzles arrayed in an array direction at a nozzle density to discharge a liquid onto a medium being conveyed in a conveyance direction intersecting the array direction. The three or more nozzle arrays include a downstream nozzle array disposed at the most downstream in the conveyance direction among the three or more nozzle arrays. The downstream nozzle array has the nozzle density equal to a sum of nozzle densities of a plurality of arrays of the three or more nozzle arrays disposed upstream from the downstream nozzle array in the conveyance direction.

As described above, according to one aspect of the present disclosure, a liquid discharge head can be provided that reduces the deviation of the landing position of liquid without a complicated control mechanism to form a desired image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
multiple nozzle arrays each having nozzles arrayed in an array direction to discharge a liquid onto a medium being conveyed in a conveyance direction intersecting the array direction,
the multiple nozzle arrays including:
a first nozzle array disposed at the most downstream in the conveyance direction among the multiple nozzle arrays, the first nozzle array having the nozzles arranged at a first nozzle density in the array direction; and
a second nozzle array upstream from the first nozzle array in the conveyance direction, the second nozzle array having the nozzles arranged at a second nozzle density in the array direction lower than the first nozzle density.

2. The liquid discharge head according to claim 1,
wherein the multiple nozzle arrays include multiple second nozzle arrays including the second nozzle array,
the first nozzle array discharges the liquid from the nozzles onto the medium to form a first image on the medium, the first image having first dots arranged at a first dot density,
the multiple second nozzle arrays discharge the liquid from the nozzles to form a second image on the medium, the second image having second dots arranged at a second dot density equal to the first dot density, and
the second dot density is obtained by summing a number of the second dots in the multiple second nozzle arrays.

3. The liquid discharge head according to claim 1,
wherein the second nozzle array has the nozzles arrayed at even intervals in the array direction.

4. The liquid discharge head according to claim 1,
wherein the multiple nozzle arrays include multiple second nozzle arrays including the second nozzle array, and
each of the multiple second nozzle arrays has the nozzles arranged at the same nozzle density.

5. The liquid discharge head according to claim 1,
wherein the multiple nozzle arrays include multiple second nozzle arrays including the second nozzle array,
the second nozzle array includes an upstream second nozzle array disposed at the most upstream of the multiple second nozzle arrays in the conveyance direction, and
the upstream second nozzle array has the lowest second nozzle density in the second nozzle density of each of the multiple second nozzle arrays.

6. The liquid discharge head according to claim 5,
wherein one of the multiple second nozzle arrays has the second nozzle density equal to or higher than the second nozzle density of an adjacent one of the multiple second nozzle arrays adjacent to and upstream from the one of the multiple second nozzle arrays in the conveyance direction.

7. The liquid discharge head according to claim 1,
wherein the multiple nozzle arrays include multiple second nozzle arrays including the second nozzle array,
at least one of the multiple second nozzle arrays has the nozzles arrayed at uneven intervals in the array direction,
the second nozzle array includes an upstream second nozzle array disposed at the most upstream of the multiple second nozzle arrays in the conveyance direction, and
the upstream second nozzle array has the lowest second nozzle density in the second nozzle density of each of the multiple second nozzle arrays.

8. The liquid discharge head according to claim 7,
wherein, one of the multiple second nozzle arrays has the second nozzle density equal to or higher than the second nozzle density of an adjacent one of the multiple second nozzle arrays adjacent to and upstream from the one of the multiple second nozzle arrays in the conveyance direction.

9. A liquid discharge unit comprising multiple liquid discharge head including the liquid discharge head according to claim 1.

10. A liquid discharge unit comprising:
the liquid discharge head according to claim 1; and
at least one of:
a head tank to store a liquid to be supplied to the liquid discharge head;
a carriage to mount the liquid discharge head;
a supply mechanism to supply the liquid to the liquid discharge head;
a maintenance mechanism to maintain and recover the liquid discharge head; or
a main-scanning moving mechanism to move the liquid discharge head in a main scanning direction,
wherein the at least one thereof is integrated with the liquid discharge head as a single unit.

11. A liquid discharge apparatus comprising:
the liquid discharge head according to claim 1; and
a conveyor to convey the medium to the liquid discharge head.

12. A liquid discharge apparatus comprising:
the liquid discharge unit according to claim 9; and
a conveyor to convey the medium to the liquid discharge unit.

13. A liquid discharge apparatus comprising:
the liquid discharge head according to claim 2; and
a conveyor to convey the medium to the liquid discharge head.

14. The liquid discharge apparatus according to claim 13,
wherein the multiple second nozzle arrays discharge the liquid from the nozzles to form the second image having the second dots aligned in the array direction at the same position in the conveyance direction on the medium.

15. The liquid discharge head according to claim 2,
wherein one of the multiple second nozzle arrays has the nozzles shifted in the array direction from the nozzles of an adjacent one of the multiple second nozzle arrays adjacent to and upstream from the one of the multiple second nozzle arrays in the conveyance direction.

16. The liquid discharge head according to claim 15,
wherein the first nozzle array has the nozzles shifted in the array direction from the nozzles of each of the multiple second nozzle arrays.

17. The liquid discharge head according to claim 2,
wherein a number of the multiple second nozzle arrays is three or more,
the multiple second nozzle arrays include:
an upstream second nozzle array disposed at the most upstream of the multiple second nozzle arrays in the conveyance direction; and
a downstream second nozzle array disposed at the most downstream of the multiple second nozzle arrays in the conveyance direction,
the upstream second nozzle array has the same second nozzle density as the downstream second nozzle array, and
other nozzle arrays of the multiple second nozzle arrays other than the upstream second nozzle array and the downstream second nozzle array have the second nozzle density higher than the same second nozzle density of the upstream second nozzle array and the downstream second nozzle array.

18. A liquid discharge head comprising:
three or more nozzle arrays each having nozzles arrayed in an array direction at a nozzle density to discharge a liquid onto a medium being conveyed in a conveyance direction intersecting the array direction,
the three or more nozzle arrays including a downstream nozzle array disposed at the most downstream in the conveyance direction among the three or more nozzle arrays, and
the downstream nozzle array having the nozzle density equal to a sum of nozzle densities of a plurality of arrays of the three or more nozzle arrays disposed upstream from the downstream nozzle array in the conveyance direction.
